(19) United States
(12) Patent Application Publication
(10) Pub. No.: US 2017/0051370 A1
(43) Pub. Date: Feb. 23, 2017

(54) LANCE NOZZLE, METHOD FOR MANUFACTURING LANCE NOZZLE AND APPARATUS FOR MANUFACTURING LANCE NOZZLE

(71) Applicant: SEOUL ENGINEERING CO., LTD., Incheon (KR)

(72) Inventor: Hae-Yang LEE, Incheon (KR)

(73) Assignee: SEOUL ENGINEERING CO., LTD., Incheon (KR)

(21) Appl. No.: 15/305,474

(22) PCT Filed: Oct. 8, 2015
(86) PCT No.: PCT/KR2015/010688

§ 371 Date: Oct. 20, 2016

(30) Foreign Application Priority Data
Oct. 10, 2014 (KR) 10-2014-0136500

(51) Int. Cl. C21C 5/46; B22D 25/02; B21K 21/08; F27D 3/16

(52) U.S. Cl. CPC C21C 5/4606; F27D 3/16; B22D 25/02; B21K 21/08; F27D 2003/169

(57) ABSTRACT

Provided is a method and an apparatus for manufacturing a lance nozzle comprising: a casting step for primarily manufacturing the lance nozzle comprising a plurality of discharge pipes, which discharge a gas supplied through an inlet to an outlet, and a front wall with a plurality of discharge holes, each of which is connected to the outlet of the discharge pipe; and a forging step for forming forging structure by forging a circumference of the discharge holes in a front surface of the front wall positioned on an opposite side to the discharge pipes.

### TECHNICAL FIELD

The present invention disclosed herein relates to a lance nozzle, a method for manufacturing a lance nozzle and an apparatus for manufacturing a lance nozzle, and more particularly, to a lance nozzle, a method for manufacturing a lance nozzle and an apparatus for manufacturing a lance nozzle, including a forging process.

### BACKGROUND ART

The lance nozzle is used in a converter of producing steel by spraying oxygen so as to stir molten steel and erupts the oxygen in a state of proximity to the molten steel in the converter, which maintains a temperature of about 1,600° C. Under such operating condition, a surface temperature of the lance nozzle can rise up to 400° C. or more temporarily and falls into 20° C. rapidly when the lance nozzle pull back to the upper portion. Therefore, the lance nozzle is manufactured by very superior thermal conductive material (for example, cupper) and thereby may effectively exchange heat to cooling fluid flowing at a high speed according to interior walls.

However, the field has adopted an approach that sets a specific number of uses of the lance nozzle and changes the lance nozzle if reaching to the specific number of uses because the lance nozzle is damaged or worn at a terminal side of a discharge pipe in a process of discharging the oxygen.

### DISCLOSURE

### Technical Problem

The object of the present invention is to provide a lance nozzle, a method for manufacturing a lance nozzle and an apparatus for manufacturing a lance nozzle, which are capable of improving durability.

The another object of the present invention is to provide a lance nozzle, a method for manufacturing a lance nozzle and an apparatus for manufacturing a lance nozzle, which are capable of saving time and expenses required for the manufacturing.

The still other object of the present invention will be further apparent from the following detailed description and the accompanying drawings.

### Technical Solution

Embodiments of the present invention provide a method for manufacturing a lance nozzle comprising: a casting step for primarily manufacturing the lance nozzle comprising a plurality of discharge pipes, which discharge a gas supplied through an inlet to an outlet, and a front wall with a plurality of discharge holes, each of which is connected to the outlet of the discharge pipe; and a forging step for forming forging structure by forging a circumference of the discharge holes in a front surface of the front wall positioned on an opposite side to the discharge pipes.

In some embodiment, in the casting step, a closing member may be formed in the inside of the discharge pipe and parts other than a front portion of the discharge pipe are closed by the closing member, and in the forging step, a forging process may be made in a state of forming the closing member.

In some embodiment, the method may further comprise a rough machining step for rough machining the front surface of the lance nozzle, after the casting step and before the forging step.

In some embodiment, the method may further comprise a finish machining step for eliminating a stair gap between the forging structure and portions other than the forging structure of the front surface via finish machining, after the forging step.

In some embodiment, a height of the forging structure may be lower than a height of the front surface before the finish machining step.

In some embodiment, the forging step may comprise forming the forging structure using a hammer with an external diameter larger than a diameter of the discharge holes.

In other embodiment, an apparatus for manufacturing a lance comprising a plurality of discharge pipes, which discharge a gas supplied through an inlet to an outlet, and a front wall with a plurality of discharge holes, each of which is connected to the outlet of the discharge pipe, the apparatus comprising: a bed, on which the lance nozzle is installed and which supports the lance nozzle so that the front surface of the lance nozzle is towards an upper portion in keeping a horizontal state; a hammer installed on the bed and having an external diameter larger than a diameter of the discharge hole; and a hammer driving member for driving the hammer and forging a circumference of the discharge hole of the front surface.

In some embodiment, the bed may support the lance nozzle in a state of being inserted into the inside of the front wall and have the same shape as the inside of the front wall.

In some embodiment, the apparatus may further comprise a guide tip protruded from the lower surface of the hammer and having an external diameter smaller than a diameter of the discharge hole, the guide tip being positioned in the discharge hole when the lower surface of the hammer contacts with the front surface.

In some embodiment, a lance nozzle comprising: a plurality of discharge pipes, which discharge a gas supplied through an inlet to an outlet; and a front wall with a plurality of discharge holes, each of which is connected to the outlet of the discharge pipe, wherein the front wall has forging structure and casting structure, and the forging structure is positioned on a circumference of the discharge hole and has a predetermined depth.

In some embodiment, the method further comprises an opening step of opening the discharge pipe by eliminating the closing member, after the forging step.

In still other embodiment, a method for manufacturing a lance nozzle comprising: a casting step for primarily manufacturing the lance nozzle via a casting process; and a forging step for forming forging structure by forging a circumference of discharge holes in a front surface of an outside front wall positioned on an opposite side to discharge pipes, using a lower surface of a hammer having an external diameter larger than a diameter of the discharge hole, wherein the lance nozzle comprises: an inside front wall forming a plurality of openings; a central pipe, a front end of which is closed by the inside front wall; an internal pipe coaxially arranged around of the central pipe, a cooling fluid is fed to an internal ring-shaped cavity formed between the internal pipe and the central pipe; an external pipe arranged coaxially around of the central pipe, the cooling fluid from the internal ring-shaped cavity is discharged to an external ring-shaped cavity formed between the internal pipe and the external pipe; the outside front wall positioned in the front of the central pipe with a plurality of discharge holes arranged in a row of the openings and closing the front end of the external pipe; a plurality of discharge pipes connected to the openings and the discharge holes and discharging gas supplied via the opening to the discharge holes.

In some embodiment, in the casting step, a closing member may be formed in the inside of the discharge pipe and parts other than a front portion of the discharge pipe are closed by the closing member, and in the forging step, a forging process may be made in a state of forming the closing member.

In some embodiment, the method may further comprise an opening step of opening the discharge pipes by eliminating the closing member after the forging step.

### Advantageous Effects

According to one embodiment of the present invention, it can prevent the terminal side of the discharge hole, which discharge the stirring gas (for example, oxygen) from be worn or damaged by forging the lance nozzle primarily manufactured via the casting, and thereby can extend a change period of the lance nozzle. In addition, it can reduce time and costs required for the manufacturing, compared with the lance nozzle manufactured by brazing two or more forging parts because the present invention manufactures the lance nozzle via the casting primarily and then forges the main part of the lance nozzle. Also, it can solve disadvantage such as defects capable of occurring at brazing the lance nozzle.

### DESCRIPTION OF DRAWINGS

FIG. 1 is a schematic view of a lance nozzle according to an embodiment of the present invention.

FIGS. 2 to 4 are graphs sequentially illustrating a method of manufacturing the lance nozzle of FIG. 1.

FIG. 5 is a photograph comparing the lance nozzles according to whether forging process is carried out after casting or not.

FIG. 6 is a photograph of enlarging a circumference of discharge holes of FIG. 5.

FIG. 7 is a structure photograph of a circumference of the discharge holes according to whether forging process is carried out or not.

FIG. 8 is a graph illustrating a result of wear test for a circumference of the discharge holes according to whether forging process is carried out or not.

FIG. 9 is a schematic view of an apparatus for manufacturing the lance nozzle of FIG. 1.

### BEST MODE

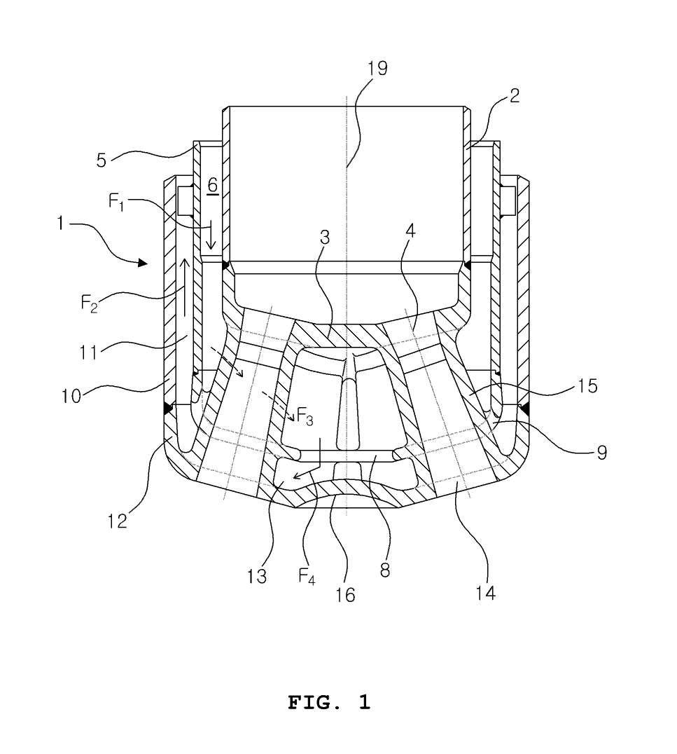

Hereinafter, exemplary embodiments of the present invention will be described in detail with reference to FIGS. 1 to 9. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. In the drawings, the shapes of components are exaggerated for clarity of illustration.

FIG. 1 is a schematic view of a lance nozzle according to an embodiment of the present invention. The lance nozzle comprises a central pipe 2 supplying a stirring gas (for example, oxygen). The central pipe 2 is closed by a front wall 3 with openings 4 and the openings 4 may be arranged at equal angles on the circumference of the central pipe 2 on a basis of an axis 19.

An internal pipe 5 is arranged around the central pipe 2 coaxially to the central pipe 2 and a ring-shaped cavity 6 is formed between the internal pipe 5 and the central pipe 2 so that the cooling fluid is fed in a direction of an arrow F₁.

An external pipe 10 is arranged around the central pipe 2 coaxially to the central pipe 2 and a ring-shaped cavity 11 is formed between the internal pipe 5 and the external pipe 10 so that the cooling fluid is discharged to a direction of an arrow F₂. The external pipe 10 is closed by a front wall 12, which faces a converter to be stirred and is subjected to threshold thermal stress. The cooling fluid flows a thermal exchange space 13 formed between the front wall 3 and the front wall 12 (F₁, F₃). The front wall 12 may preferably be manufactured by thermal conductive materials having a high heat transfer coefficient such as cupper to provide sufficient thermal exchange between the cooling fluid and the heated front wall 12. That is, the cooling fluid flowed from the cavity 6 bypasses discharge pipes 15 and flows into the thermal exchange space 13 via a passage 8 (F₄), and flows towards the cavity 11 in a direction of the arrow F₁.

In addition, the front wall 12 has discharge holes 14 arranged in a row of the openings 4 formed on the front wall 3, and the discharge pipes 15 are connected to the openings 4 and the discharge holes 14 so as to discharge the stirring gas (for example, oxygen) to the outside of the lance nozzle 1. The discharge pipes 15 inclines towards the outside to the front on a basis of the axis 19 and a front surface of the lance nozzle 1 is substantially perpendicular to central axes of the discharge pipes 15. Therefore, the front surface of the front wall 12 has a shape, which inclines towards the outside to the lower side on a basis of the axis 19. Also, the front wall 12 has a sink part 16 in the center, which is concave towards the passage 8, and a cooling fluid exhaust nozzle 9 is formed between the discharge pipes 15 and the internal pipe 5.

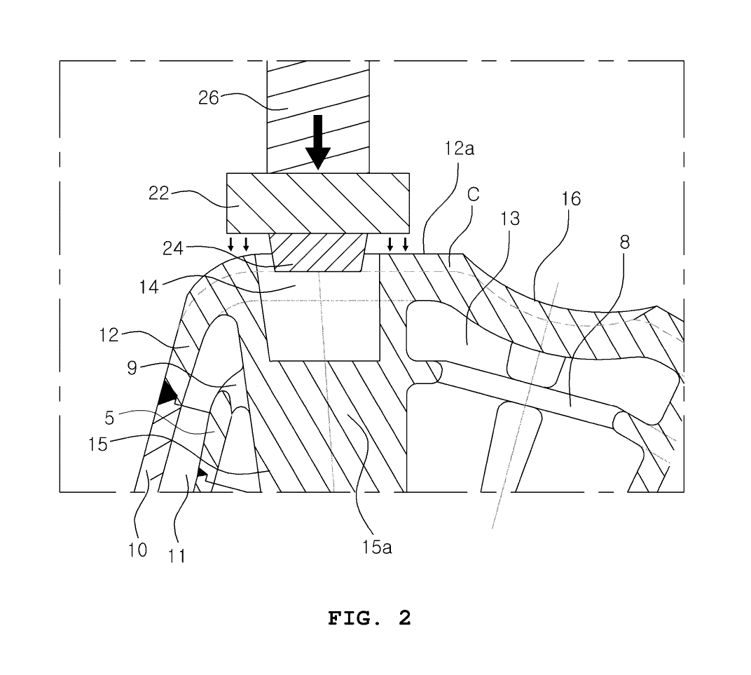

FIGS. 2 to 4 are graphs sequentially illustrating a method of manufacturing the lance nozzle of FIG. 1. The lance nozzle illustrated in FIG. 1 as above can be manufactured through the method as described below.

First, the lance nozzle 1 may be manufactured as one unit via casting or be manufactured as two or more units and then be connected by welding. The casting has an advantage, which can mass-produce things having the same shape and the same size because the casting makes the same things by pouring a liquid into a mold. Particularly, the casting has an advantage, which can save the processing costs because it can easily manufacture products having a complicated shape.

Then, the lance nozzle 1 goes through rough machining and has surplus portion C (a thickness=about 10 mm) before finish machining in a state of completing the rough machining as illustrated in FIG. 2. In this situation, the lance nozzle 1 is preheated to 500-750° C. using a torch and thereafter forging process is carried out to the circumference of the discharge holes 14 using a hammer 22. The hammer 22 has an external diameter lager than a diameter of the discharge holes 14 and applies compressive load (or impact load) to the front surface 12a of the lance nozzle 1 in manner of applying an impact (for example, in manner of lifting and free-falling the hammer 22 using a driving cylinder, or forcibly falling the lifted hammer 22 using the driving cylinder). The hammer 22 is to forge the circumference of the front surface of the front wall 3 and does not contact with an inner peripheral surface of the discharge hole 14 until completing the forging process and is not inserted to the inside of the discharge hole 14.

At this time, a closing member 15a is formed in the inside of the discharge pipe 15 via the casting process and closes a portion of the inside of the discharge pipe 15. In the forging process, the closing member 15a prevents the discharge hole 14 or the discharge pipe 15 from deformation (for example, increasing a diameter). That is, in the forging process of the lance nozzle, only a portion of the front terminal of the discharge pipe 15 is partially hollowed and a portion of the inside of the discharge pipe 15 is closed. After the forging process is completed, the discharge pipe 15 is completely formed by eliminating the closing member 15a and thus opening the discharge pipe 15 as illustrated in FIG. 1.

A guide tip 24 is protruded from the lower surface of the hammer 22 and has an external diameter smaller than the diameter of the discharge hole 14 after the forging process is completed. The guide tip 24 may have a trapezoidal shaped cross-section, the upper diameter of which is larger than the lower diameter. When the hammer 22 contacts with the front surface 12a, the guide tip 24 is inserted into the discharge hole 13 and guides the hammer 22 so as to accurately apply the compressive load to the circumference of the discharge hole 14.

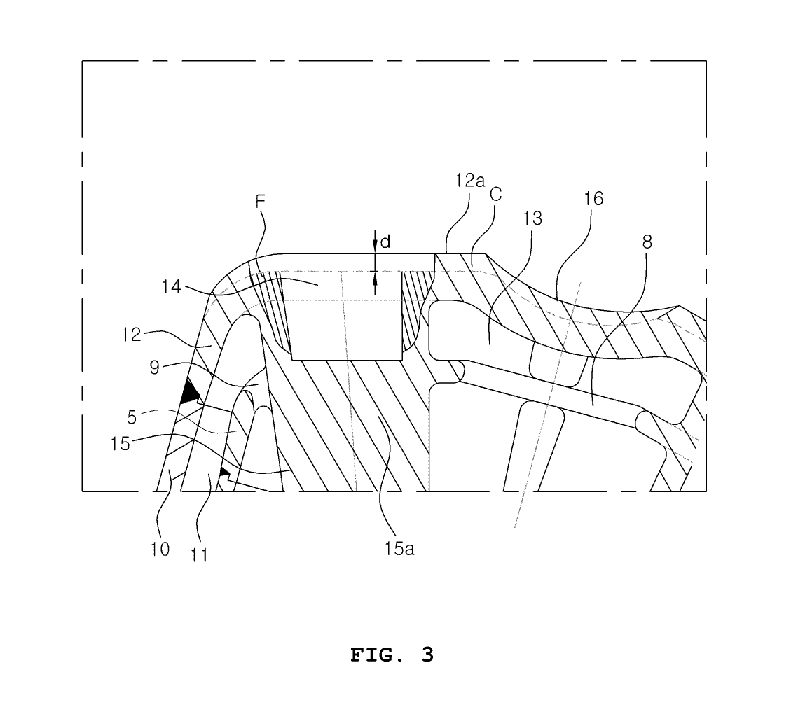

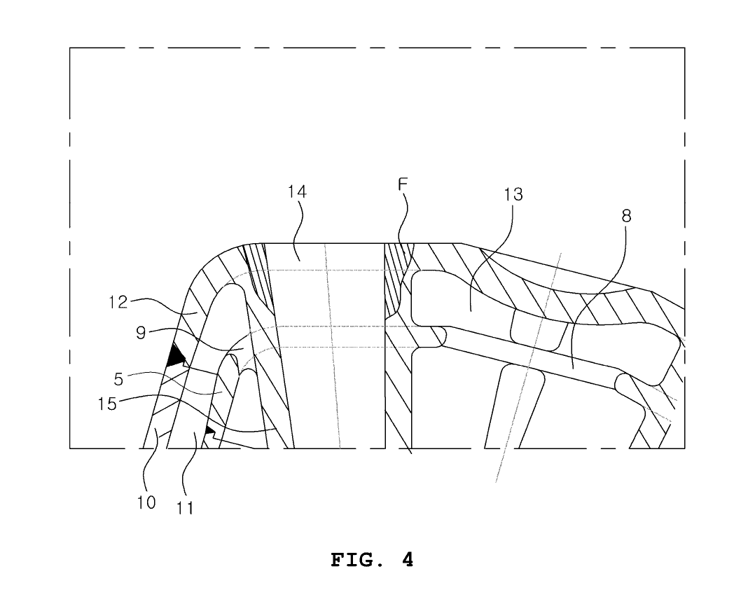

As illustrated in FIG. 3, if the forging process is completed, forging structure F is formed on the circumference of the discharge hole 14 and the forging structure F is formed in a ring-shape with constant thickness and depth. At this time, in the process of densifying the structure through the forging process, stair gap d is formed between the forging structure F and the front surface 12a and the thickness of the stair gap d may be identified with that of the surplus portion C. Therefore, as illustrated in FIG. 4, if eliminating the surplus portion C (or the stair gap) and the closing member 15a via the finish machining, the final lance nozzle 1 is accomplished.

According to this embodiment of the present invention, both the advantage of the casting process and the advantage of the forging process can be utilized and at the same time, the disadvantage of the casting process can be compensated by the forging process while the disadvantage of the forging process can be compensated by the casting process. That is, the casting process is a process of melting metal and cooling/freezing the metal to the required shape and thus has the disadvantage that mechanical properties of the casting metal is inferior to the product made by the other process with the same materials because the structure of the casting metal has rough crystalline structure often referred to as a cast structure. Consequently, in a case of the lance nozzle 1 as described the above, there is a problem that the terminal side of the discharge pipes 15 (or the surroundings of the discharge holes 14) erupting the stirring gas is easily worn or damaged.

On the other hand, the forging process can improve the mechanical properties such as strength because it applies the compressive load or impact load to the material so as to densifying the metal structure compared with the casting process. Therefore, the forging process can extend the lance nozzle's lifetime but has a problem that a lot of time and costs is spent on the manufacturing.

Consequently, the present invention reduces the time and costs on the manufacturing by manufacturing primarily the lance nozzle via the casting process and at the same time, reinforces the terminal side of the discharge pipes 15 (or the surroundings of the discharge holes 14) easily worn or damaged by improving the mechanical properties via the forging process.

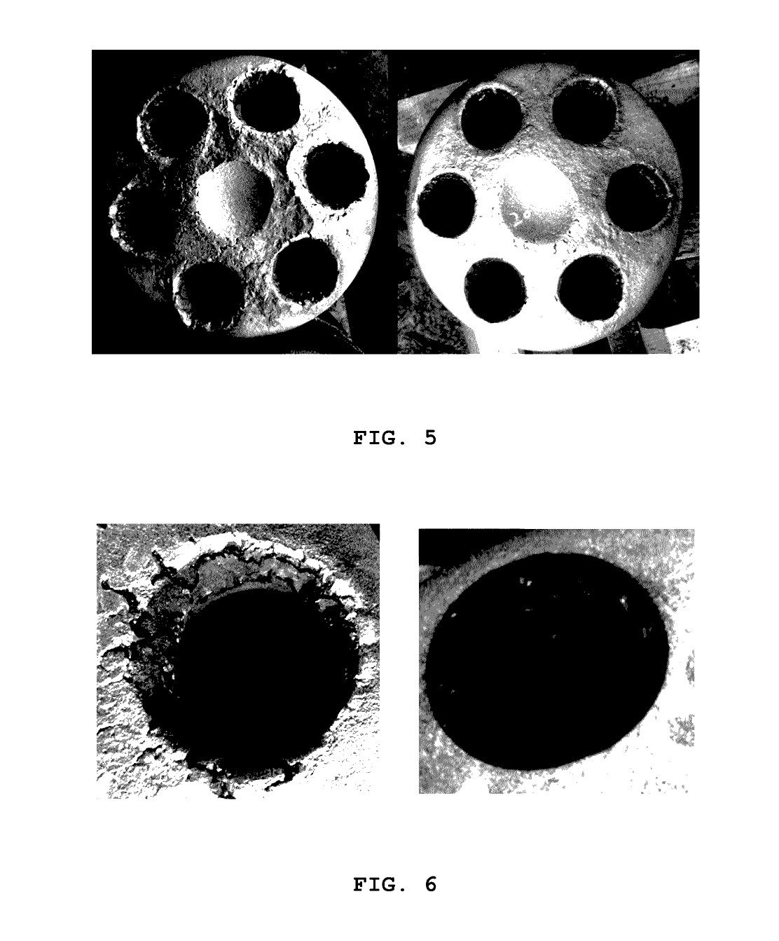

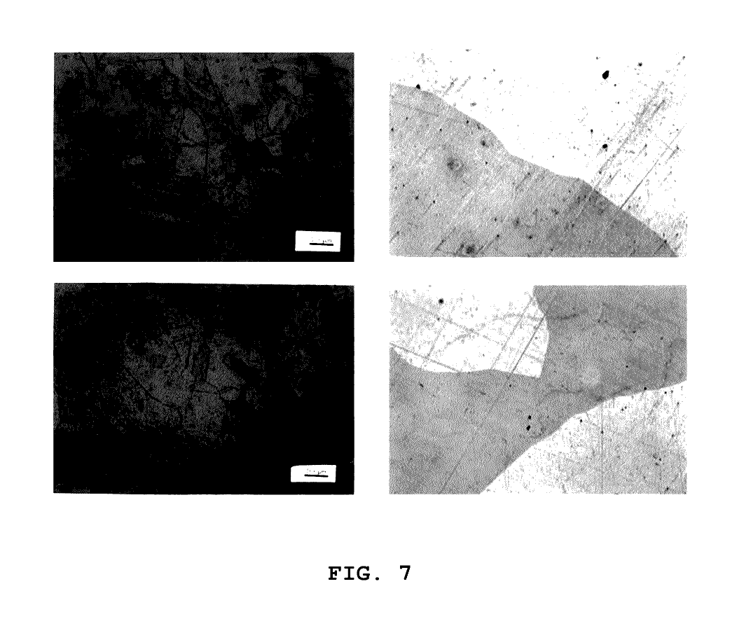

FIG. 5 is a photograph comparing the lance nozzles according to whether forging process is carried out or not after casting, and FIG. 6 is a photograph of enlarging the circumference of discharge holes of FIG. 5. FIGS. 5 and 6 show the lance nozzle, which has been used 150 times, and the left side is in the case that the forging process is not carried out and the right side is in the case that the forging process is carried out. As illustrated in FIGS. 5 and 6, in the case that the forging process is not carried out, it is verified that there is a crack on the terminal side of the discharge pipes 15 (or the surroundings of the discharge holes 14) but in that case that the forging process is carried out, it is verified that there is no crack on the terminal side of the discharge pipes 15 (or the surroundings of the discharge holes 14)

FIG. 7 is a structure photograph of a circumference of the discharge holes according to whether forging process is carried out or not. The left side is in the case that the forging process is not carried out and the right side is in the case of the forging process is carried out. As illustrated in FIG. 7, if the forging process is carried out, the metal structure is changed to be densified and thus it can improve the mechanical properties such as strength because the metal structure becomes densified compared with the casting process. But, if the forging process is not carried out, the metal structure is not dense relatively and has a few of grain boundaries. Meanwhile, the forging structure and the casting structure can be coexisted according to the degree of the forging process after the casting process and the more increased the number of the forging process, the more increased the amount of the forging structure.

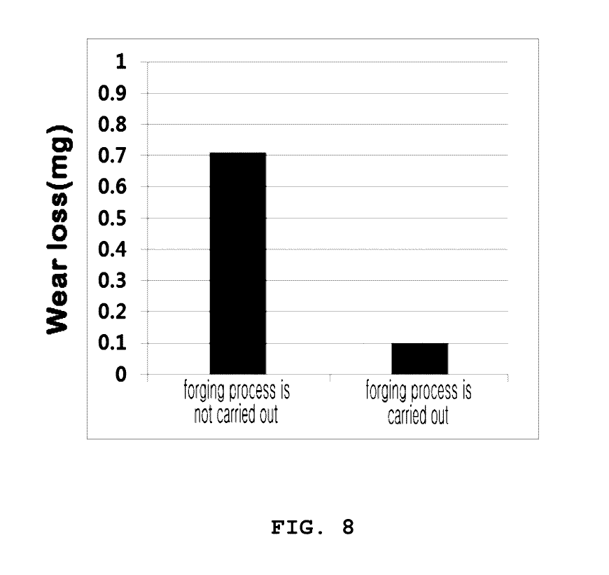

FIG. 8 is a graph illustrating a result of wear test for a circumference of the discharge holes according to whether forging process is carried out or not. Under the test condition as below [Table 1], the wear test was carried out to the structure of the lance nozzle 1, which is subjected to the forging process, and the structure of the lance nozzle 1, which is not subjected to the forging process.

TABLE 1

| Wear test condition | |
|---|---|
| test standard | ASTM G99, pin-on-disk sliding wear test |
| pin, counterpart | Al₂O₃ alumina ball |
| disk, specimen | |
| applied load | 100 N |
| sliding speed | 0.1 m/s |
| sliding distance | 100 m |
| Temperature | room temperature |
| humidity | 34% |

As a result, as illustrated in FIG. 8, the wear loss of the lance nozzle 1, to which the forging process is not carried out, is 0.7 mg but the wear loss of the lance nozzle 1, to which the forging process is carried out. That is, it can be verified that the mechanical properties of the lance nozzle 1 can be improved through the forging process. Especially, it can be verified that wear resistance of the lance nozzle 1 increases 7 times or more.

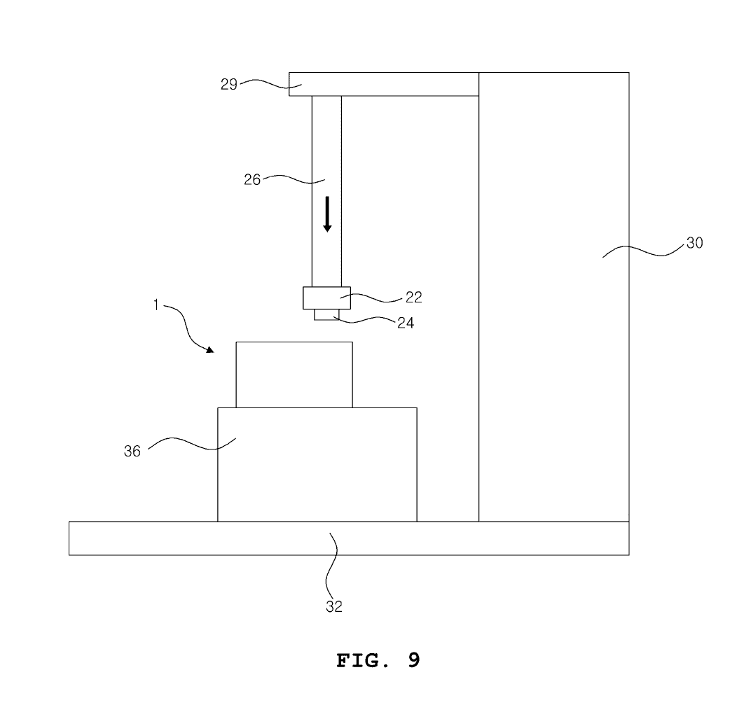

FIG. 9 is a schematic view of an apparatus for manufacturing the lance nozzle of FIG. 1. The apparatus for manufacturing the lance nozzle comprises a bed 36 placed on a base 32 and the bed 32 fixedly supports the lance nozzle 1 so as to maintaining the front surface 12a of the lance nozzle 1 horizontally.

The apparatus for manufacturing the lance nozzle 1 further comprises a support frame 29 and the support frame 29 is maintained in a fixed state. A support rod 26 is installed through the support frame 29 and the hammer 22 is fixed to the lower end of the support rod 26. The support rod 26 is operated by a separate driving device (not shown) and on the operation, the hammer 22 carries out the forging process by applying the compressive load (or the impact load) on the front surface of lance nozzle 1.

Specifically, the lance nozzle 1 is fixed on the bed so that the front surface 12a of the lance nozzle 1 is towards the upper portion and a torch heats the lance nozzle 1 up to the appropriate temperature for the forging process (for example, 500-750° C.). Thereafter, the bed 36 is moved to a body 30 and the position of the bed 36 is adjusted so that the discharge hole 14 of the lance nozzle 1 to be forged is positioned just below the hammer 22. If the position adjustment of the bed 36 is completed, the driving device (for example, a driving cylinder) is operated so as to carry out the forging process on the circumference of the discharge hole 14 using the hammer 22. And then, if the forging process is completed, the bed 36 is moved in the opposite direction of the body 36 and the lance nozzle 1 is removed from the bed 36.

Although the present invention is described in detail with reference to the exemplary embodiments, the invention may be embodied in many different forms. Thus, technical idea and scope of claims set forth below are not limited to the preferred embodiments.

What is claimed is:

1. A method for manufacturing a lance nozzle comprising:
a casting step for primarily manufacturing the lance nozzle comprising a plurality of discharge pipes, which discharge a gas supplied through an inlet to an outlet, and a front wall with a plurality of discharge holes, each of which is connected to the outlet of the discharge pipe; and
a forging step for forming forging structure by forging a circumference of the discharge holes in a front surface of the front wall positioned on an opposite side to the discharge pipes.

2. The method of claim 1, wherein in the casting step, a closing member is formed in the inside of the discharge pipe and parts other than a front portion of the discharge pipe are closed by the closing member, and in the forging step, a forging process is made in a state of forming the closing member.

3. The method of claim 2, further comprising:
an opening step of opening the discharge pipe by eliminating the closing member, after the forging step.

4. The method of claim 1, further comprising:
after the casting step and before the forging step,
a rough machining step for rough machining the front surface of the lance nozzle.

5. The method of claim 4, further comprising:
after the forging step,
a finish machining step for eliminating a stair gap between the forging structure and portions other than the forging structure of the front surface via finish machining.

6. The method of claim 5, wherein a height of the forging structure is lower than a height of the front surface before the finish machining step.

7. The method of claim 1, wherein the forging step comprises forming the forging structure using a hammer with an external diameter larger than a diameter of the discharge holes.

8. An apparatus for manufacturing a lance comprising a plurality of discharge pipes, which discharge a gas supplied through an inlet to an outlet, and a front wall with a plurality of discharge holes, each of which is connected to the outlet of the discharge pipe, the apparatus comprising:
a bed, on which the lance nozzle is installed and which supports the lance nozzle so that the front surface of the lance nozzle is towards an upper portion in keeping a horizontal state;
a hammer installed on the bed and having an external diameter larger than a diameter of the discharge hole; and
a hammer driving member for driving the hammer and forging a circumference of the discharge hole of the front surface.

9. The apparatus of claim 8, wherein the bed supports the lance nozzle in a state of being inserted into the inside of the front wall and have the same shape as the inside of the front wall.

10. The apparatus of claim 8, further comprising:
a guide tip protruded from the lower surface of the hammer and having an external diameter smaller than a diameter of the discharge hole, the guide tip being positioned in the discharge hole when the lower surface of the hammer contacts with the front surface.

11. A lance nozzle comprising:
a plurality of discharge pipes, which discharge a gas supplied through an inlet to an outlet; and
a front wall with a plurality of discharge holes, each of which is connected to the outlet of the discharge pipe,
wherein the front wall has forging structure and casting structure, and the forging structure is positioned on a circumference of the discharge hole and has a predetermined depth.

12. A method for manufacturing a lance nozzle comprising:
a casting step for primarily manufacturing the lance nozzle via a casting process; and
a forging step for forming forging structure by forging a circumference of discharge holes in a front surface of an outside front wall positioned on an opposite side to discharge pipes, using a lower surface of a hammer having an external diameter larger than a diameter of the discharge hole,
wherein the lance nozzle comprises:
an inside front wall forming a plurality of openings;
a central pipe, a front end of which is closed by the inside front wall;
an internal pipe coaxially arranged around of the central pipe, a cooling fluid is fed to an internal ring-shaped cavity formed between the internal pipe and the central pipe;
an external pipe arranged coaxially around of the central pipe, the cooling fluid from the internal ring-shaped cavity is discharged to an external ring-shaped cavity formed between the internal pipe and the external pipe;
the outside front wall positioned in the front of the central pipe with a plurality of discharge holes arranged in a row of the openings and closing the front end of the external pipe;
a plurality of discharge pipes connected to the openings and the discharge holes and discharging gas supplied via the opening to the discharge holes.

13. The method of claim 12, wherein in the casting step, a closing member is formed in the inside of the discharge pipe and parts other than a front portion of the discharge pipe are closed by the closing member, and in the forging step, a forging process is made in a state of forming the closing member.

14. The method of claim 13, further comprising:
an opening step of opening the discharge pipes by eliminating the closing member after the forging step.
